(19) United States
(12) Patent Application Publication
(10) Pub. No.: US 2018/0268353 A1
(43) Pub. Date: Sep. 20, 2018

(54) OBJECT HANDLING APPARATUS

(71) Applicant: KABUSHIKI KAISHA TOSHIBA, Minato-ku (JP)

(72) Inventors: Atsushi SUGAHARA, Kawasaki (JP); Kazuma KOMODA, Fuchu (JP); Hideichi NAKAMOTO, Tokyo (JP); Junya TANAKA, Tokyo (JP); Akihito OGAWA, Fujisawa (JP); Haruna ETO, Tokyo (JP)

(73) Assignee: KABUSHIKI KAISHA TOSHIBA, Minato-ku (JP)

(21) Appl. No.: 15/689,097

(22) Filed: Aug. 29, 2017

(30) Foreign Application Priority Data
Mar. 17, 2017 (JP) 2017-052675

(51) Int. Cl. G06Q 10/08

(52) U.S. Cl. CPC G06Q 10/087; A47F 1/125

(57) ABSTRACT

According to one embodiment, an object handling apparatus includes a first mechanism and a second mechanism. The first mechanism draws an adapter arranged in a rack, one or more objects being placed on the adapter. The second mechanism moves the one or more objects toward a side where the one or more objects are taken out from the adapter.

### CROSS-REFERENCE TO RELATED APPLICATIONS

This application is based upon and claims the benefit of priority from Japanese Patent Application No. 2017-052675, filed Mar. 17, 2017, the entire contents of which are incorporated herein by reference.

### FIELD

Embodiments described herein relate generally to an object handling apparatus.

### BACKGROUND

Arranging articles in the racks in shops and logistics centers at present is mostly manual work. As such, there is a demand for automation of the work out of concern over manpower constraints due to the aging population and falling birth rate. It is generally required that articles are arranged in the racks in shops and logistics centers following the “First In, First Out (FIFO)” rule, in which newer articles are placed from behind so that older articles come to the front and customers and workers may first pick up the articles with a closer expiration date. However, with the difficulties in article-package recognition and handling, the automation of such arrangement work has hardly developed to date.

In addition, shops and logistics centers need inventory work to check the expiration date of every article in the racks and to discard the expired articles. This work also requires significant manpower costs and has led to a demand for automation.

### BRIEF DESCRIPTION OF THE DRAWINGS

FIG. 1 illustrates an object handling apparatus according to a first embodiment.

FIG. 2 illustrates an example of a drawer adapter according to the embodiment.

FIG. 3 illustrates an example of the drawer adapter on which objects are placed.

FIG. 4 illustrates a modification example of the drawer adapter.

FIG. 5 illustrates a modification example of the drawer adapter on which objects are placed.

FIG. 6A is a side view showing an example of the drawer adapters arranged in a rack.

FIG. 6B is a front view showing an example of the drawer adapters arranged in the rack.

FIG. 7A is a perspective view showing a first phase of a drawing action by the object handling apparatus.

FIG. 7B is a side view showing the first phase of the drawing action by the object handling apparatus.

FIG. 8A is a perspective view showing a second phase of the drawing action by the object handling apparatus.

FIG. 8B is a side view showing the second phase of the drawing action by the object handling apparatus.

FIG. 9A is a perspective view showing a third phase of the drawing action by the object handling apparatus.

FIG. 9B is a side view showing the third phase of the drawing action by the object handling apparatus.

FIG. 10 is for explaining an inspection operation by the object handling apparatus according to the first embodiment.

FIG. 11 is a block diagram showing the object handling apparatus according to the first embodiment.

FIG. 12 is a flowchart for controlling the drawing action and the inspection operation by the object handling apparatus.

FIG. 13A is a perspective view of an object handling apparatus according to a second embodiment.

FIG. 13B is a side view of the object handling apparatus according to the second embodiment.

FIG. 14A is a perspective view showing a first phase of a placing operation by the object handling apparatus.

FIG. 14B is a plan view showing the first phase of the placing operation by the object handling apparatus.

FIG. 15A is a perspective view showing a second phase of the placing operation by the object handling apparatus.

FIG. 15B is a plan view showing the second phase of the placing operation by the object handling apparatus.

FIG. 16A is a perspective view showing a third phase of the placing operation by the object handling apparatus.

FIG. 16B is a plan view showing the third phase of the placing operation by the object handling apparatus.

FIG. 17 is for explaining a shelf taking-out operation by the object handling apparatus.

FIG. 18 is a block diagram showing the object handling apparatus according to the second embodiment.

FIG. 19 is a flowchart for controlling the placing operation by the object handling apparatus.

FIG. 20 is a flowchart for controlling the taking-out operation by the object handling apparatus.

FIG. 21 is for explaining a container transfer process according to the third embodiment.

FIG. 22 shows a specific example of the container transfer process.

FIG. 23 is for explaining an operation to arrange the drawer adapters.

### DETAILED DESCRIPTION

In general, according to one embodiment, an object handling apparatus includes a first mechanism and a second mechanism. The first mechanism draws an adapter arranged in a rack, one or more objects being placed on the adapter. The second mechanism moves the one or more objects toward a side where the one or more objects are taken out from the adapter.

### First Embodiment

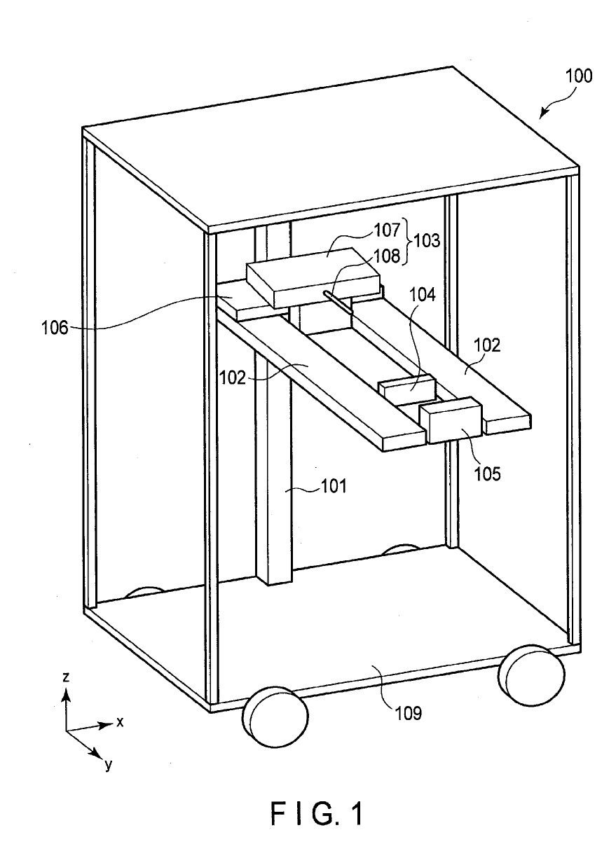

An object handling apparatus according to the first embodiment will be described with reference to FIG. 1.

An object handling apparatus 100 according to this embodiment includes a first vertical member 101, a horizontal member 102, an object supporting mechanism 103, a drawing mechanism 104, an object positioning mechanism 105, and a vertical movement mechanism 106. The object handling apparatus 100 is intended to be mounted on a cart 109.

The first vertical member 101 extends in the z direction shown in FIG. 1 when mounted on the cart 109. The z direction is defined to be perpendicular to the face of the platform of the cart 109.

The horizontal member 102 is connected to the later-described vertical movement mechanism 106 and extends on a plane that intersects perpendicularly with the first vertical member 101. The horizontal member 102 is intended to have a look of, for example, a forklift that may be formed of two parallel members or an integral U-shaped member.

The object supporting mechanism 103 is provided at the gap in the horizontal member 102 for connection, and is movable in the extending direction (y direction) of the horizontal member 102. The object supporting mechanism 103 supports the objects on a drawer adapter.

The object supporting mechanism 103 includes, for example, a horizontal movement mechanism 107 and a supporting member 108. The horizontal movement mechanism 107 moves the supporting member 108 along the extending direction (y direction) of the horizontal member 102. The horizontal movement mechanism 107 includes, for example, a linear motion mechanism such as a ball screw. The supporting member 108 is a mechanical component connected to the horizontal movement mechanism 107 and is capable of increasing and decreasing its length in the y direction. The supporting member 108 is formed of, for example, a zip chain comprising two strands of chains that are engaged with each other in a manner to allow pushing and pulling, or is an elastic body such as a spring. The supporting member 108 is assumed to be a rod shape, but may also be a plate shape. In other words, the supporting member 108 may have any shape, as long as its end portion for contacting an object will not damage the object. From the viewpoint of space conservation, it is desirable to provide a take-up mechanism (not illustrated) inside or outside the object supporting mechanism 103 so that the supporting member 108 may retract into the take-up mechanism.

The drawing mechanism 104 is provided at the gap in the horizontal member 102 for connection, and movable in the extending direction of the horizontal member 102 as well as in the direction vertical to the horizontal member 102 (z direction). The drawing mechanism 104 includes a convex member and a linear- and vertical-motion mechanism that supports the convex member to be movable in the extending direction (y direction) and the vertical direction (z direction). The linear- and vertical-motion mechanism may be a combination of a linear motion mechanism for the extending-direction movement and another linear motion mechanism for the vertical movement, or may be constituted as, for example, an arm movable in the three-dimensional space. The linear motion mechanisms may be realized by, for example, ball screws. The drawing mechanism 104 draws out the later-described drawer adapters which are located in a rack and on which one or more objects are placed.

The object positioning mechanism 105 is provided at the gap in the horizontal member 102 and connected on a further frontward side from the drawing mechanism 104 (+y, side). The object positioning mechanism 105 is movable in the extending direction of the horizontal member 102 as well as in the direction vertical to the horizontal member 102. The object positioning mechanism 105 includes a convex member (push finger) and a linear- and vertical-motion mechanism that supports the convex member to be movable in the extending direction (y direction) and the vertical direction (z direction). The linear- and vertical-motion mechanism may be a combination of a linear motion mechanism for the extending-direction movement and another linear motion mechanism for the vertical movement, or may be constituted as, for example, an arm movable in the three-dimensional space. The object positioning mechanism 105 moves the objects placed on the drawer adapter (or shift them) toward the side where the objects will be taken out from the drawer adapter.

The vertical movement mechanism 106 is connected to the horizontal member 102 and the first vertical member 101, and movable in the vertical direction. The vertical movement mechanism 106 moves the horizontal member 102 and the first vertical member 101 along the extending direction (z direction) of the first vertical member 101. The vertical movement mechanism 106 is, for example, a linear motion mechanism such as a ball screw.

The cart 109 may be a general cart, as long as the object handling apparatus 100 can be fixedly mounted thereon.

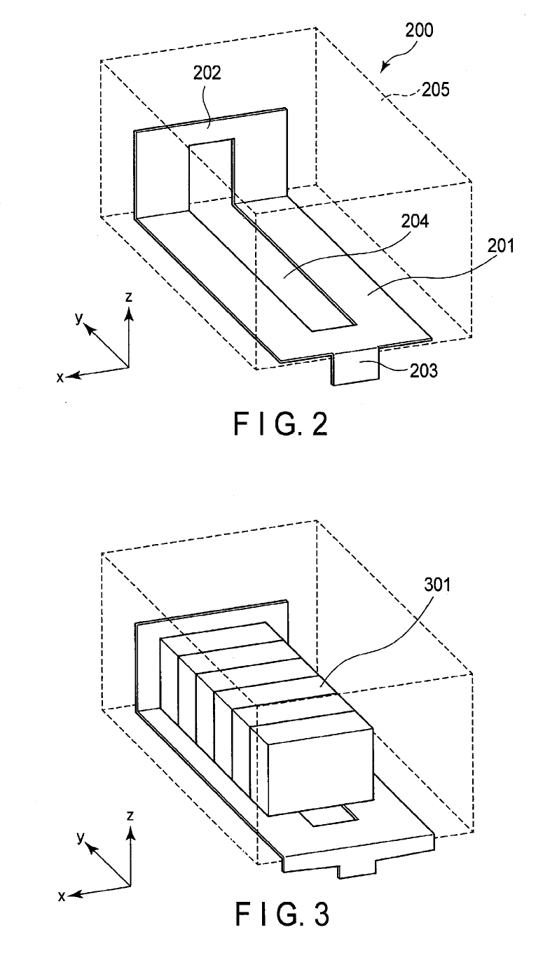

The drawer adapter according to this embodiment will now be described with reference to FIGS. 2 and 3.

A drawer adapter 200 shown in FIG. 2 includes a first plate 201, a second plate 202, and a third plate 203. The cuboid shown by dotted lines assumes a region 205 when the drawer adapter 200 is arranged in a rack.

The first plate 201 has a surface on which one or more objects are placed, and an opposing surface for landing on the rack shelf. The first plate 201 serves as a bottom face of the adapter 200.

The second plate 202 is connected to a first edge of the first plate 201, and extends in the vertical direction (in this instance, +z direction). The first edge of the first plate 201 may typically be an edge on the inner side of the rack or, in other words, an edge located on the side opposite the side of the slot for taking out articles. The second plate 202 serves as a back face of the adapter 200.

The third plate 203 is connected to a second edge of the first plate 201, opposite the first edge, and extends in the vertical direction (in this instance, −z direction). The second edge of the first plate 201 may typically be an edge located on the side of the slot for taking out articles. The third plate 203 and the second plate 202 extend in the opposing directions in the example shown in FIG. 2, but they may extend in the same direction (+z direction).

In the first plate 201 and the second plate 202, a continuous hole 204 is formed. Note that the first plate 201, the second plate 202, and the third plate 203 of the drawer adapter 200 may be integrally fashioned. The first plate 201, the second plate 202, and the third plate 203 may be formed from any materials, for example, a transparent acrylic plate.

FIG. 3 shows an example of the drawer adapter 200 on which objects are placed.

As shown in FIG. 3, one or more objects 301 are arranged in the longitudinal direction of the first plate 201 of the drawer adapter 200. These objects 301 are, for example, articles sharing a similar shape, such as commodities and catalogs, and intended to be neatly arranged. However, objects of different shapes may also be arranged as the objects 301. The objects 301 are arranged on the adapter 200 so that they bridge over the hole 204. Here, it is assumed that the side where the third plate is connected conforms to the side where the objects are taken out from the drawer adapter 200, and this side will be called a foreside in the arrangement direction, or a front side. In contrast, the side where the second plate is connected will be called a rear side in the arrangement direction, or an inner side.

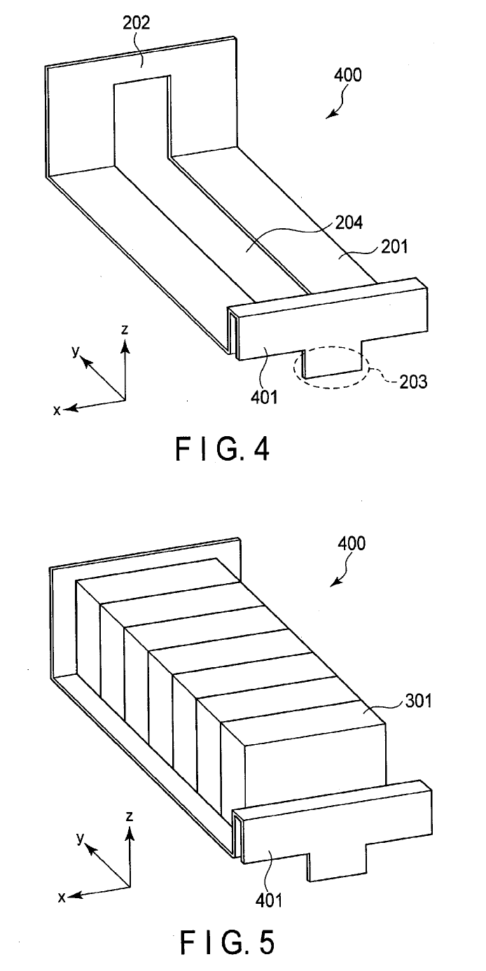

A modification example of the drawer adapter according to the present embodiment will be described with reference to FIGS. 4 and 5.

A drawer adapter 400 according to the modification example additionally includes a fourth plate 401 in the drawer adapter 200.

The fourth plate 401 is connected to the second edge, and extends in the direction perpendicular to the first plate 201. FIG. 4 is an example of the integrally-fashioned drawer adapter 400 with the first plate 201 having been folded to constitute the fourth plate 401 while constituting the second plate 202 at the other end. The fourth plate 401 and the third plate 203 may be integrally formed as a T-shape plate, which is then connected to the second edge perpendicularly with respect to the surface. The fourth plate 401 and the third plate 203 may be separately formed and connected to each other. The fourth plate 401 may be formed from any materials, for example, a transparent acrylic plate.

FIG. 5 shows an example of the drawer adapter 400 according to the modification example when objects are placed thereon.

As shown in FIG. 5, the fourth plate 401 can serve as a screen against the objects 301 so that the objects 301 are prevented from dropping.

The fourth plate 401 can also display item descriptions by carrying item tags, barcodes, etc. affixed thereto. If the end portion of the first plate 201 is bent into the fourth plate 401, item tags and barcodes may be inserted into the folded portion. In this instance, the fourth plate is preferably formed from a transparent material, such as transparent acrylics.

(Drawing Action by the Object Handling Apparatus 100)

A drawing action of the drawer adapter 200 by the object handling apparatus 100 according to the first embodiment will be described.

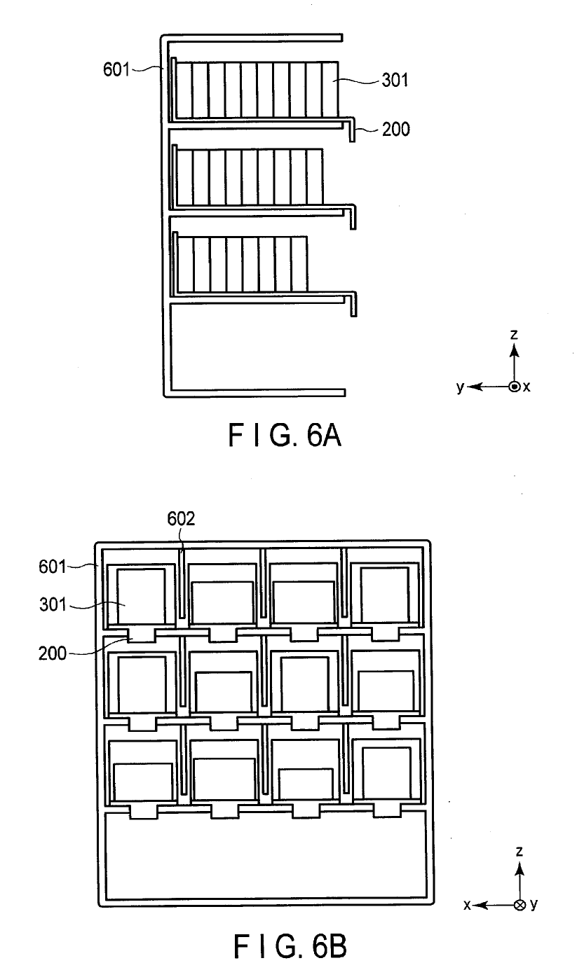

First, one exemplary arrangement of the drawer adapters 200 in a rack will be described with reference to FIGS. 6A and 6B.

Here, a case will be assumed where objects are arranged in each shelf of a display rack, as seen in the display racks of supermarkets and convenience stores. It will also be assumed that objects are arranged in the display rack in such a manner that the objects with a closer expiration date (or best-before date) will be located on the side for users to pick up (front side), while the objects that are fresh and with a relatively distant expiration date will be located on the inner side. That is, object supplementation, etc. will be done following the so-called “First In, First Out” (FIFO) rule.

FIG. 6A shows a rack 601 when viewed from the side, in which the drawer adapters 200 have been arranged. The drawer adapters 200 are arranged in the respective shelves of the rack 601. A plurality of objects 301 are placed on the drawer adapters 200.

FIG. 6B is a front view of the rack 601. The objects 301 are provided laterally and longitudinally. Partition plates 602 are disposed between the neighboring objects 301 so that the objects 301 are prevented from being mingled with neighboring, different-kind objects 301.

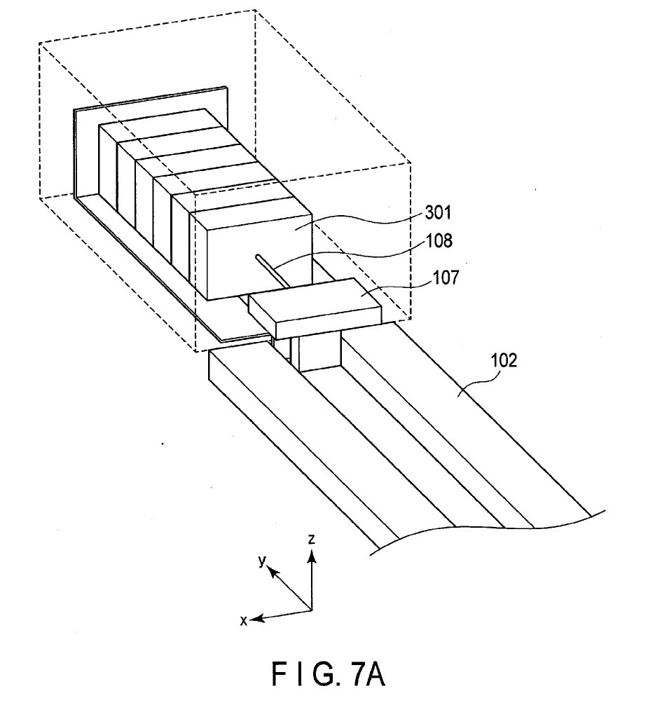

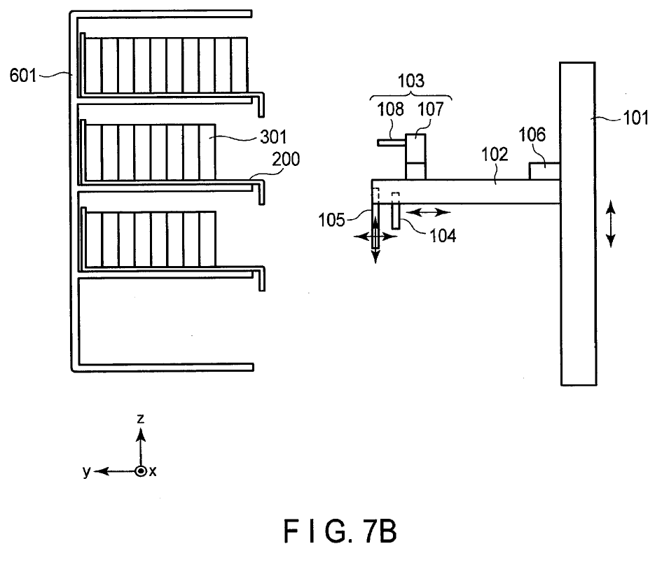

A drawing action of the drawer adapters 200 from the rack 601 will be described with reference to FIGS. 7 to 9.

FIG. 7A is a perspective view showing a first phase of the drawing action by the object handling apparatus 100, and FIG. 7B is a side view showing the first phase of the drawing action.

The vertical movement mechanism 106 moves to a position where the drawer adapter 200 as a drawing target can be transferred to the horizontal member 102.

The object supporting mechanism 103 moves along the extending direction of the horizontal member 102 to a position where the supporting member 108 can contact the object 301 on the drawer adapter 200.

The drawing mechanism 104 moves to a position where it makes contact with the third plate 203 of the drawer adapter 200. The expression “contact” may refer to a state where the drawing mechanism 104 is hooked on the back of the third plate 203, or a state where the drawing mechanism 104 sticks to the third plate 203 by vacuum contact. For example, to make the hooked state at the back of the third plate 203, the drawing mechanism 104 may descend enough to avoid a possible collision with the third plate 203 that is expected during the movement. The drawing mechanism 104, having descended, is then moved to pass over the third plate 203. Thereafter, the drawing mechanism 104 may be lifted up to the point of contact with the back of the third plate 203, while moving in the drawing direction of the drawer adapter 200 (−y direction).

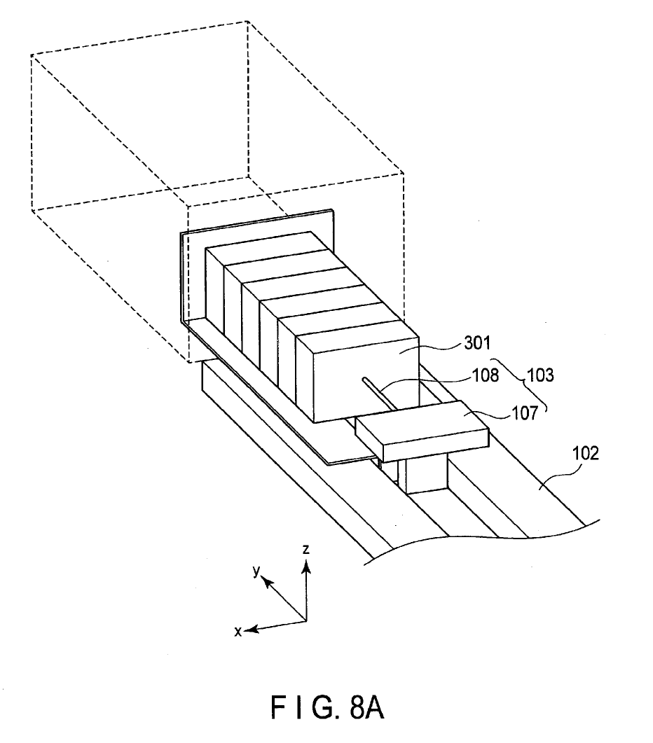

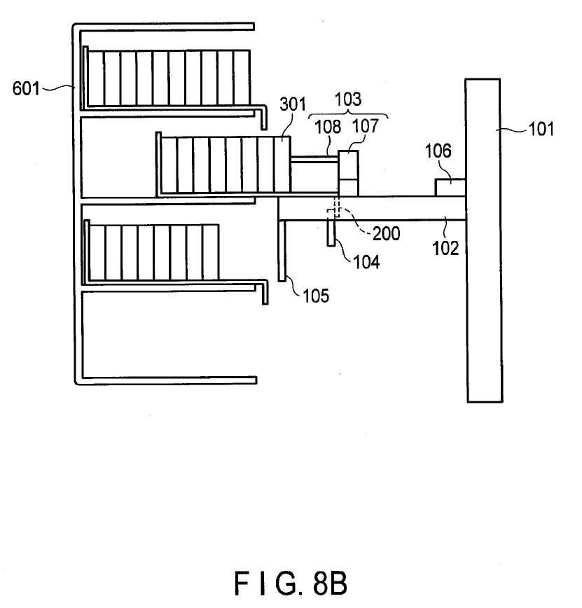

FIG. 8A is a perspective view showing a second phase of the drawing action by the object handling apparatus 100, and FIG. 8B is a side view showing the second phase of the drawing action.

By the drawing mechanism 104 moving in the −y direction while keeping the contact with the third plate 203, the drawer adapter 200 is drawn frontward. As a result, the drawer adapter 200 is transferred onto the horizontal member 102.

The drawer adapter 200 is slidably drawn on the horizontal member 102. Thus, the contact surface between the horizontal member 102 and the drawer adapter 200 may be subject to a coating treatment such as Teflon® treatment for enhanced slidability, or may be provided with rollers. By doing this, drawing the drawer adapter 200 may be more smoothly performed.

The object supporting mechanism 103 moves in the −y direction following the movement of the drawing mechanism 104, with the supporting member 108 kept in contact with the foremost object 301. This will prevent the objects 301 from falling in front at the time of drawing the drawer adapter 200. In this instance, it is preferable that the object supporting mechanism 103 is allowed to move while maintaining a pressure that would not crush the objects 301.

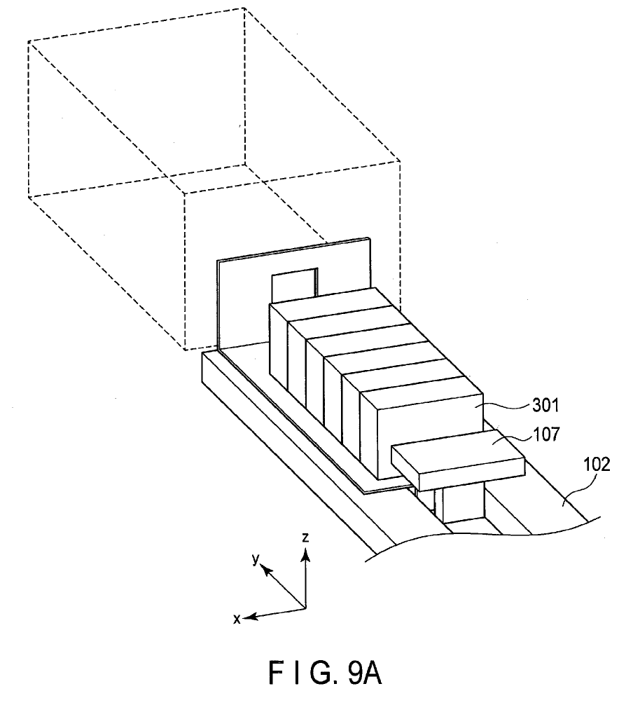

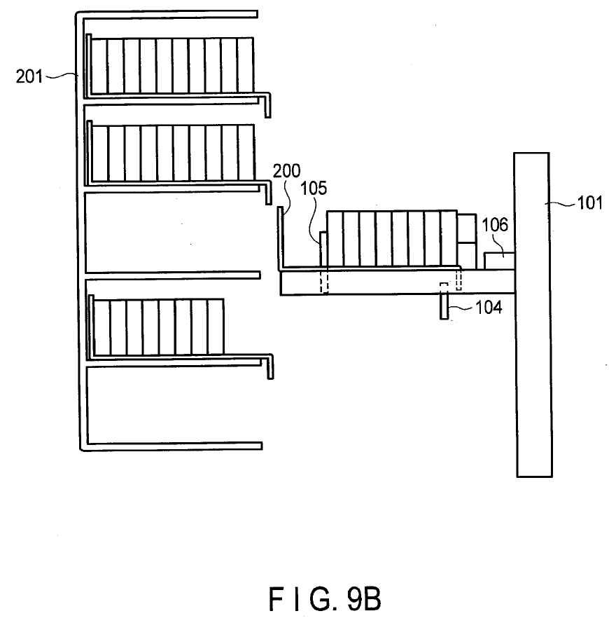

FIG. 9A is a perspective view showing a third phase of the drawing action by the object handling apparatus 100, and FIG. 9B is a side view showing the third phase of the drawing action.

To meet the FIFO rule in article supplementation processes, it is necessary to supply new objects 301 from behind after drawing the drawer adapter 200 frontward. As such, it is necessary to bring the objects 301 that have been present up until the supplementation to the front side so that a space (gap) for supplying new objects 301 can be secured. Thus, as the third phase, object positioning is performed to move the objects 301 from the rear side to the foreside in the arrangement direction.

The object positioning mechanism 105 descends in advance so that it will not collide with the drawer adapter 200 (third plate 203, etc.) when the drawer adapter 200 is being drawn. Upon completion of the transfer of the drawer adapter 200, the object positioning mechanism 105 ascends. The object positioning mechanism 105 comes through the hole 204 in the second plate 202 of the drawer adapter 200, and moves in the −y direction to shift the objects 301 toward the front side of the drawer adapter 200.

This can move the objects placed on the drawer adapter 200 toward the front side, and can form a space that allows for the supply of new objects 301 at the rear side of the drawer adapter 200. In this instance, the object supporting mechanism 103 may move in the −y direction following the movement of the object positioning mechanism 105, with the supporting member 108 kept in contact with the foremost object 301.

(Inspection Operation by the Object Handling Apparatus 100)

During the drawing action for the drawer adapter 200 described above, the object handling apparatus 100 can concurrently perform an inspection operation for the objects. The inspection operation may refer to, for example, an operation of scanning barcodes to acquire attribute information, product information, etc. of the objects 301.

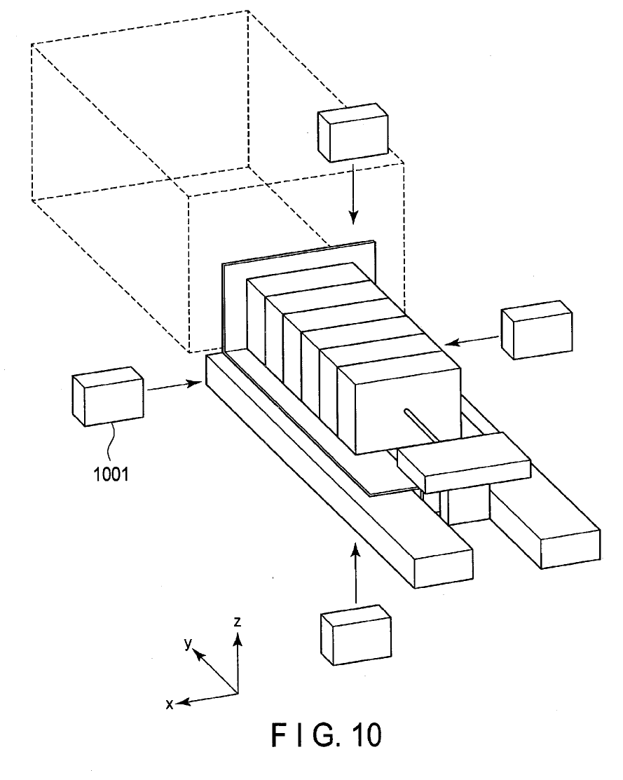

The inspection operation by the object handling apparatus 100 according to the first embodiment will be described with reference to FIG. 10.

FIG. 10 is a perspective view showing the second phase of the drawing action. The object handling apparatus 100 further includes one or more scanners 1001.

The scanner 1001 is, for example, a barcode reader that scans and acquires scan information from barcodes attached to objects. The scanner 1001 may be connected and disposed at any position of the object handling apparatus 100, provided that the scanner 1001 does not hamper the drawing action for the drawer adapter 200 and that it can appropriately scan barcodes from that position.

As shown in FIG. 10, it is preferable that the scanner 1001 is provided on each of the left, right, upper, and lower sides of the objects so that 4-way reading from these directions is enabled. Providing a single scanner as the scanner 1001 would also suffice if it is configured to be rotatable about the y axis. The scanner 1001 may scan each object 301 from the four directions to acquire the object's attribute information and product information, while rotating in conjunction with the drawing amount of the drawer adapter 200. Or, a C-arm member may be disposed around the y axis and the scanner 1001 may be configured to orbit around the y axis along this C-arm.

(Controlling the Drawing and the Inspection)

Controlling the drawing action and the inspection operation by the object handling apparatus 100 according to the first embodiment will be described.

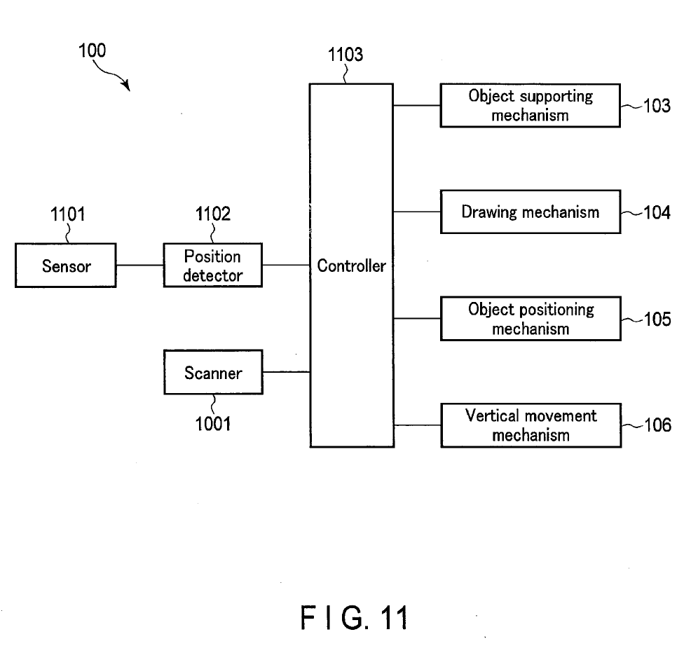

FIG. 11 is a block diagram showing the object handling apparatus 100 according to the first embodiment.

The object handling apparatus 100 according to the first embodiment includes the object supporting mechanism 103, the drawing mechanism 104, the object positioning mechanism 105, the vertical movement mechanism 106, the scanner 1001, a sensor 1101, a position detector 1102, and a controller 1103.

The sensor 1101 is, for example, a range image sensor such as a laser range finder, or a stereo camera sensor, and is capable of acquiring three-dimensional position information. The sensor 1101 obtains sensor values through sensing.

The position detector 1102 receives the sensor values from the sensor 1101 and extracts detection information about the drawer adapters 200, the objects 301, etc. The detection information includes, for example, a distance between each mechanism and the drawer adapter 200, a distance between each mechanism and the object 301, and graphic information (image information) acquired by the camera sensor.

The controller 1103 receives the scan information from the scanner 1001 and the detection information from the position detector 1102. The controller 1103 controls the driving of each of the object supporting mechanism 103, the drawing mechanism 104, the object positioning mechanism 105, and the vertical movement mechanism 106, based on the scan information and the detection information.

For example, this drive control includes generation of drive signals indicative of a drive amount for each of the object supporting mechanism 103, the drawing mechanism 104, the object positioning mechanism 105, and the vertical movement mechanism 106.

The object supporting mechanism 103, the drawing mechanism 104, the object positioning mechanism 105, and the vertical movement mechanism 106 each include an actuator. Upon receipt of the drive signals from the controller 1103, the respective actuators drive the object supporting mechanism 103, the drawing mechanism 104, the object positioning mechanism 105, and the vertical movement mechanism 106 in accordance with the drive amount indicated by the drive signals.

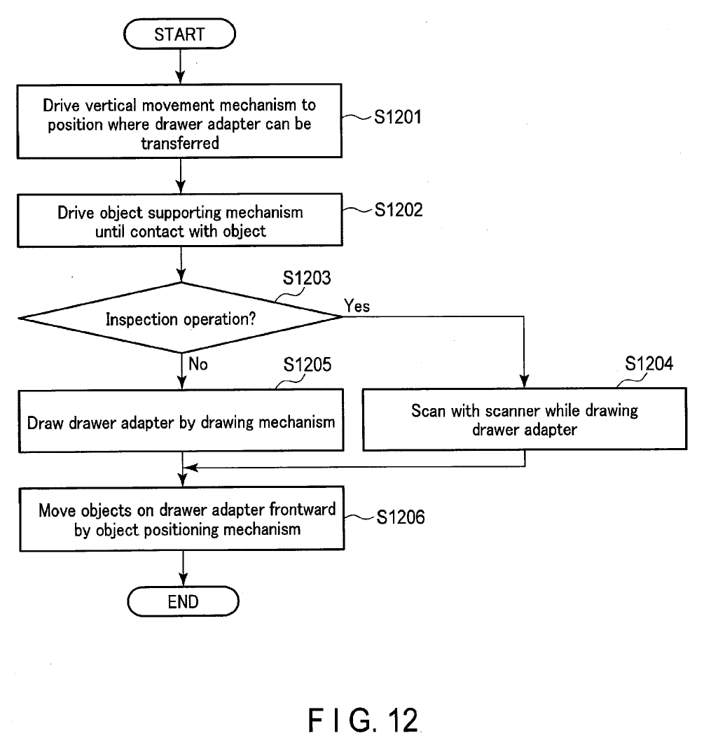

With reference to the flowchart in FIG. 12, controlling the drawing action and the inspection operation by the object handling apparatus 100 will be explained.

In step S1201, the controller 1103 drives the vertical movement mechanism 106 to the position where the drawer adapter 200 can be transferred onto the horizontal member 102. Specifically, the controller 1103 may drive the vertical movement mechanism 106 based on the detection information so that the top face of the horizontal member 102 will locate below the first plate 201 of the drawer adapter 200.

In step S1202, the controller 1103 drives the object supporting mechanism 103 until the supporting member 108 of the object supporting mechanism 103 contacts the foremost object arranged on the drawer adapter 200.

In step S1203, the controller 1103 determines whether or not the inspection operation should be performed. If it is determined that the inspection operation should be performed, the process proceeds to step S1204. If it is determined that the inspection operation should not be performed, the process proceeds to step S1205.

In step S1204, the controller 1103 drives the drawing mechanism 104 to draw the drawer adapter 200 onto the horizontal member 102 using the third plate 203 of the drawer adapter 200. At this time, the object supporting mechanism 103 is also driven to move according to the drive of the drawing mechanism 104. The inspection operation is performed at this time by the scanner 1001 scanning the objects' barcodes.

In step S1205, the controller 1103 drives the drawing mechanism 104 to draw the drawer adapter 200 onto the horizontal member 102 using the third plate 203 of the drawer adapter 200. The object supporting mechanism 103 is also driven to move according to the drive of the drawing mechanism 104. Specifically, the drawing mechanism 104 may be provided with a contact sensor, etc. (not illustrated), and the drawing mechanism 104 may be drawn frontward after the contact between the drawing mechanism 104 and the third plate 203 has been confirmed by the contact sensor.

In step S1206, the controller 1103 drives the object positioning mechanism 105 so that it contacts the rearmost object arranged on the drawer adapter 200 and moves frontward. Specifically, the movement amount that should be adopted for the frontward movement of the objects can, for example, be estimated based on the position of the object supporting mechanism 103 at the completion of the transfer of the drawer adapter 200, so the object positioning mechanism 105 may be driven according to this movement amount.

The first embodiment described above can realize the automation of the object movement and inspection operations for FIFO in a simple and low-cost manner, by providing the drawing mechanism that draws the adapters having a hole in the bottom face (first plate 201) and the back face (second plate 202), and the object positioning mechanism that comes through the hole on the back face side to shift the objects from the rear side to the foreside.

### Second Embodiment

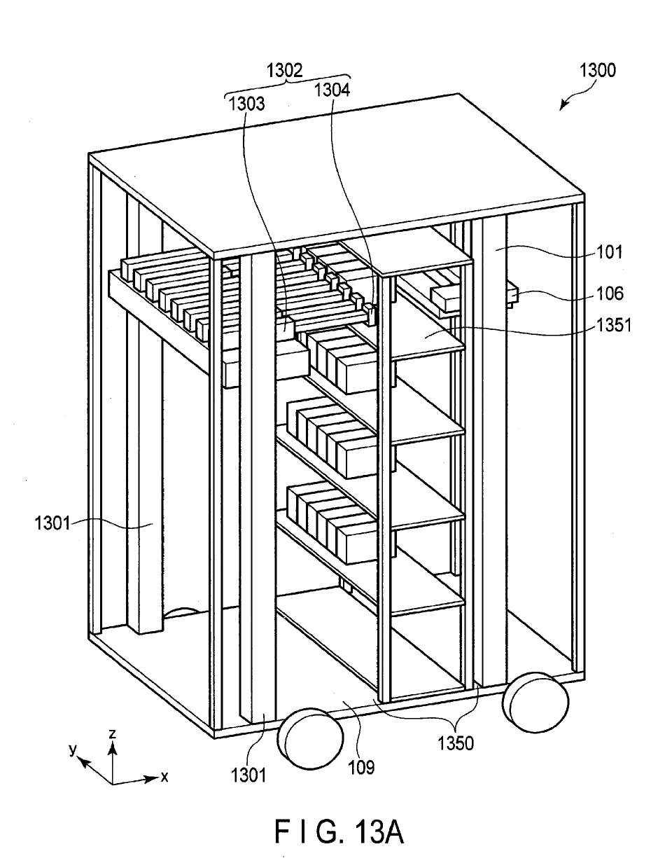

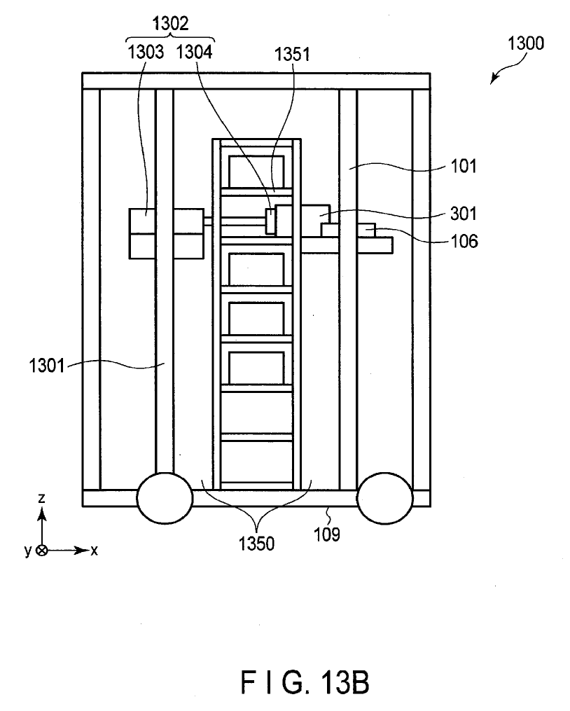

An object handling apparatus according to the second embodiment, which realizes object placing and taking-out operations, will be described with reference to FIGS. 13A and 13B.

FIG. 13A is a perspective view of an object handling apparatus 1300 according to the second embodiment, and FIG. 13B is a side view of the object handling apparatus 1300 according to the second embodiment when viewed from the y axis direction.

The object handling apparatus 1300 according to the second embodiment includes one or more second vertical members 1301 and one or more object transfer mechanisms 1302, in addition to the structures of the object handling apparatus 100 according to the first embodiment. The object transfer mechanisms 1302 each include a cylinder 1303 and a head 1304. Also, a shelf-type container 1350 is provided on the cart 109. The container 1350 includes multiple trays 1351 carrying thereon the objects to be newly arranged on the drawer adapters 200. With respect to the container 1350, multiple cylinders 1303 are equipped in the y direction.

The second vertical member 1301 extends in the z axis direction when mounted on the cart 109 with a predetermined distance from the first vertical member 101. The container 1350 is inserted into a space between the first vertical member 101 and the second vertical member 1301 apart from each other with the predetermined distance.

The object transfer mechanism 1302 is connected to the second vertical member 1301 so as to be vertically movable. As to the concrete configuration, the cylinder 1303 enables the head 1304 to go forward and backward in the x direction. The head 1304 includes, for example, a suction member capable of vacuum contact and suctions the objects. The head 1304 may include a gripper member to hold the objects.

The second embodiment assumes providing as many object transfer mechanisms 1302 as the number of objects that the tray 1351 would carry. That is, if at most 10 objects are to be placed on the tray 1351, there are 10 object transfer mechanisms 1302. However, this is not a limitation, and a single object transfer mechanism 1302 may be adopted to sequentially transfer the target objects to the drawer adapter 200.

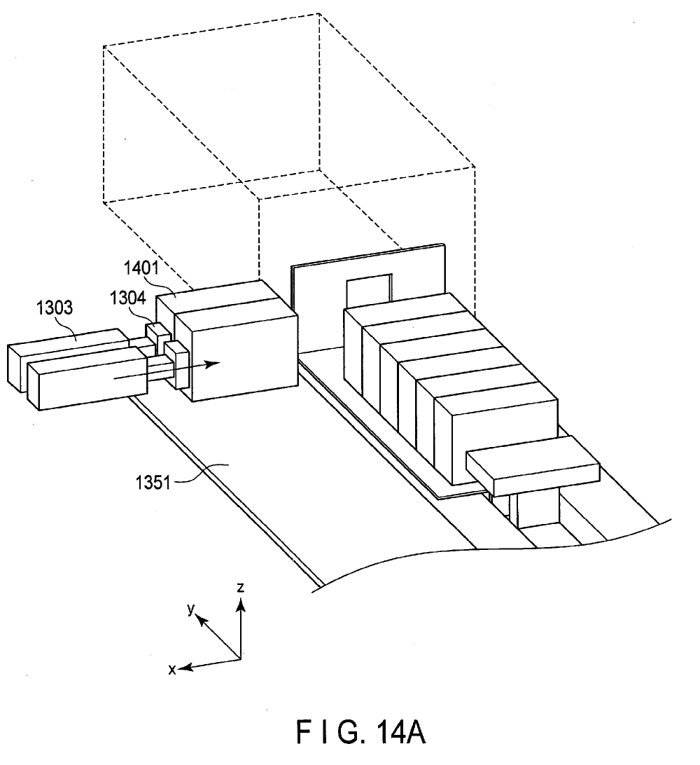

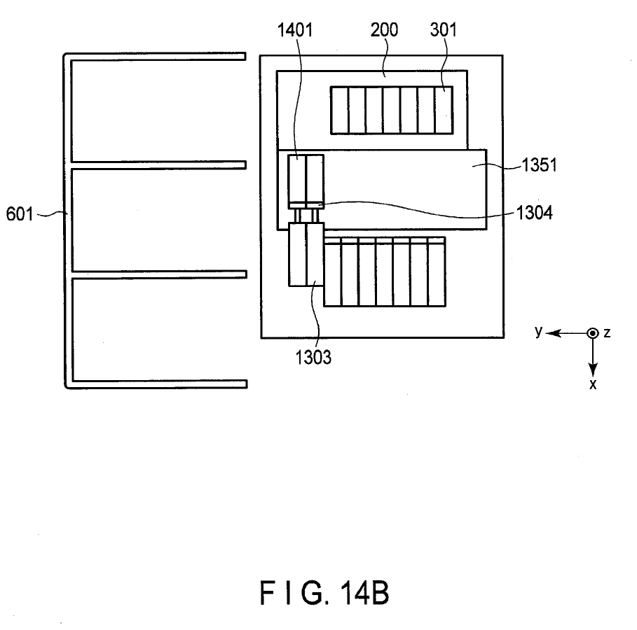

The placing operation by the object handling apparatus 1300 according to the second embodiment will be described with reference to FIGS. 14A to 16B.

FIG. 14A is a perspective view showing a first phase of the object placing operation, and FIG. 14B is a plan view showing the first phase of the placing operation when viewed from above.

Note that the objects 301 on the drawer adapter 200 are already in the state of having been shifted toward the front side, as in the third phase of the drawing action.

The cylinder 1303 causes the head 1304 to push an object 1401 on the tray 1351. The object 1401 is a new object intended for placement. The head 1304 may suck the object 1401, or may simply contact the object 1401 to only push it out. One cylinder 1303 may be used to push one object 1401, or multiple cylinders 1303 may be used to push one object 1401.

Before starting the insertion of the new objects 1401, the object positioning mechanism 105 may serve to support the rearmost object on the drawer adapter 200 so that the rearmost object does not fall. The rearmost object on the drawer adapter 200 will no longer fall when the new objects 1401 are inserted up to the state of contacting the rearmost object, and thus, the object positioning mechanism 105 may descend.

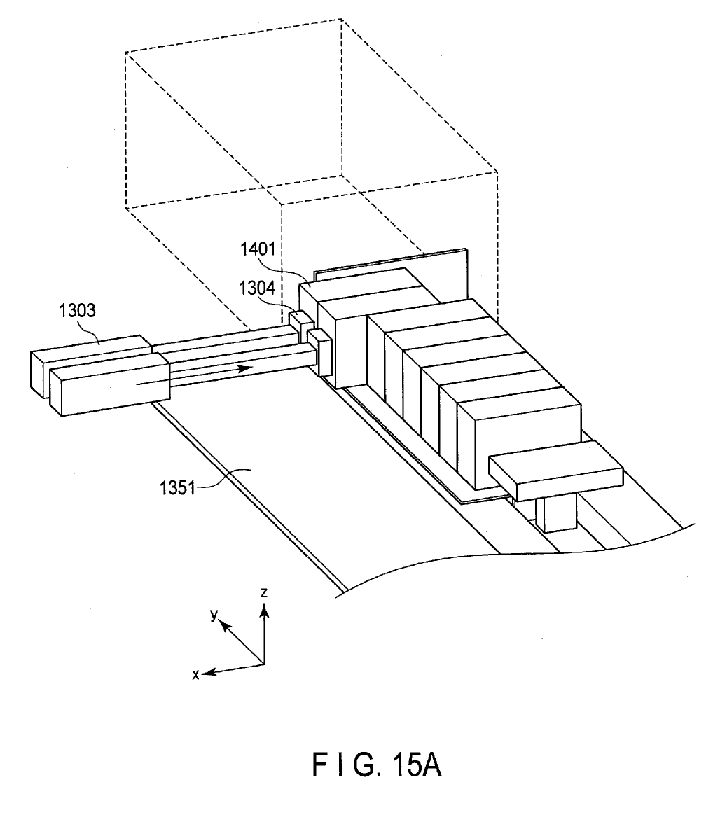

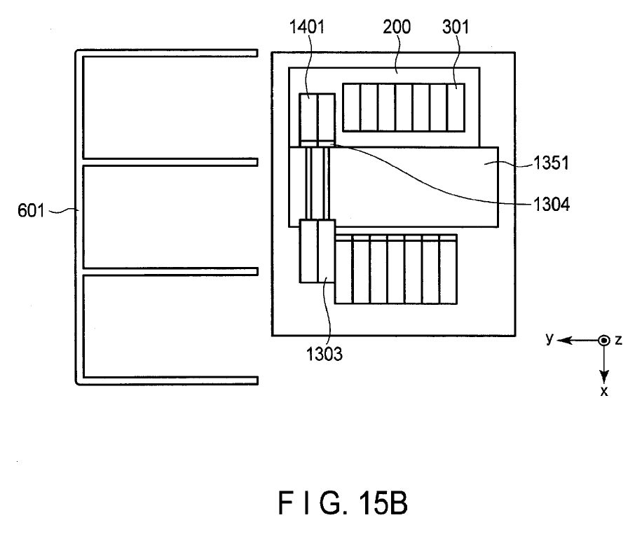

FIG. 15A is a perspective view showing a second phase of the object placing operation, and FIG. 15B is a plan view showing the second phase of the placing operation when viewed from above.

Upon inserting the object 1401 at the rearmost position on the drawer adapter 200 by the pushing of the head 1304, the transfer of the objects 1401 for this drawer adapter 200 is complete.

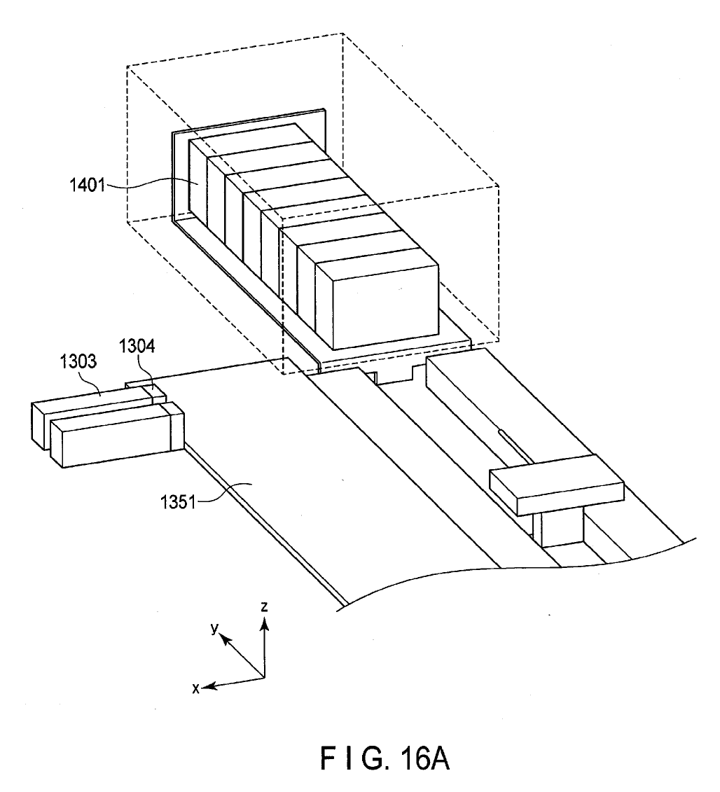

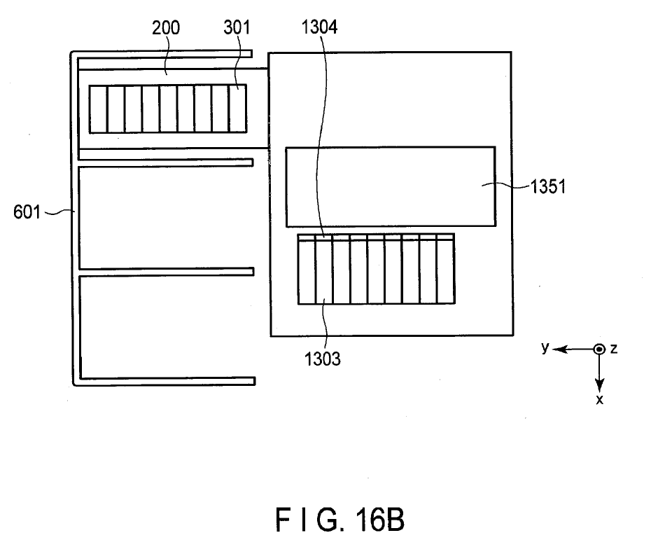

FIG. 16A is a perspective view showing a third phase of the object placing operation, and FIG. 16B is a plan view showing the third phase of the placing operation when viewed from above.

The placing operation ends upon the drawer adapter 200 returned to the rack 601. Specifically, the drawing mechanism 104 moves toward the rack 601 in such a manner as to push the third plate 203 of the drawer adapter 200. Thereby, the drawer adapter 200 can be appropriately put back to the rack 601.

(Taking Out Operation by the Object Handling Apparatus)

The object handling apparatus 1300 according to the second embodiment is not only capable of the placing operation but also capable of the taking-out operation (picking-up operation).

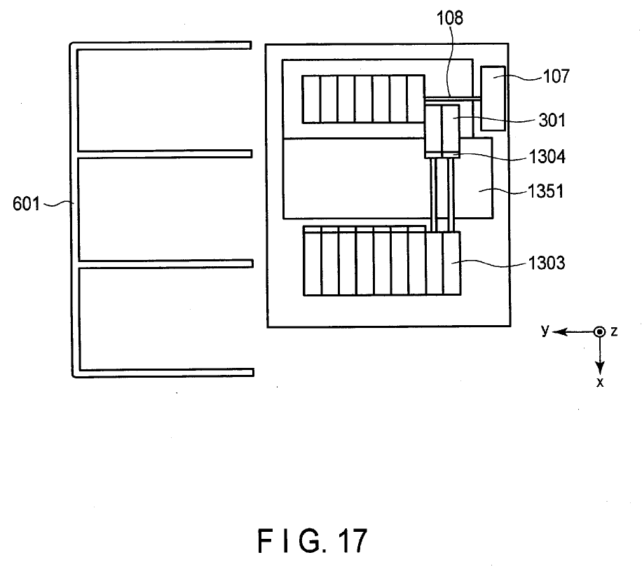

The taking-out operation by the object handling apparatus 1300 will be described with reference to FIG. 17.

FIG. 17 shows the object handling apparatus 1300 for the taking-out operation, when viewed from above.

The taking-out operation follows the FIFO rule, so the objects are taken out from the front side of the drawer adapter 200. The head 1304 of the object transfer mechanism 1302 assigned for the front object vacuum-suctions the object 301. The cylinder 1303 causes the head 1304 to retract so that the object 301 is transferred to the tray 1351 side.

At this time, upon the vacuum-suctioned object 301 being taken out, the supporting member 108 that has been in contact with the vacuum-suctioned object 301 extends to contact the foremost object among the objects 301 that are not targeted for the taking-out operation. Thereby, taking out the objects does not cause the remaining objects to fall in front.

(Controlling the Placing and Taking Out Operations)

Controlling the placing operation and the taking-out operation by the object handling apparatus 1300 according to the second embodiment will be described.

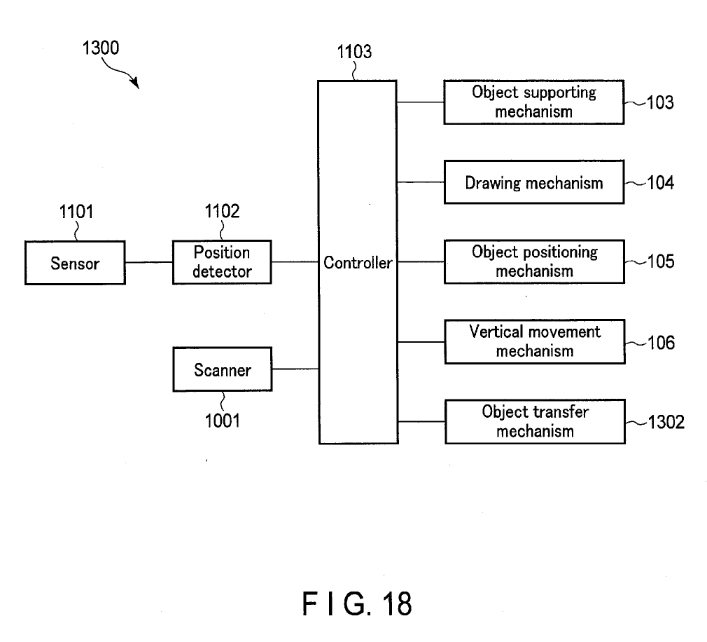

FIG. 18 is a block diagram showing the object handling apparatus 1300 according to the second embodiment.

The object handling apparatus 1300 according to the second embodiment includes one or more object transfer mechanisms 1302, in addition to the structures of the object handling apparatus 100 according to the first embodiment.

The object transfer mechanism 1302 includes an actuator. The object transfer mechanism 1302 receives drive signals from the controller 1103, and the actuator is driven in accordance with the drive amount indicated by the drive signals.

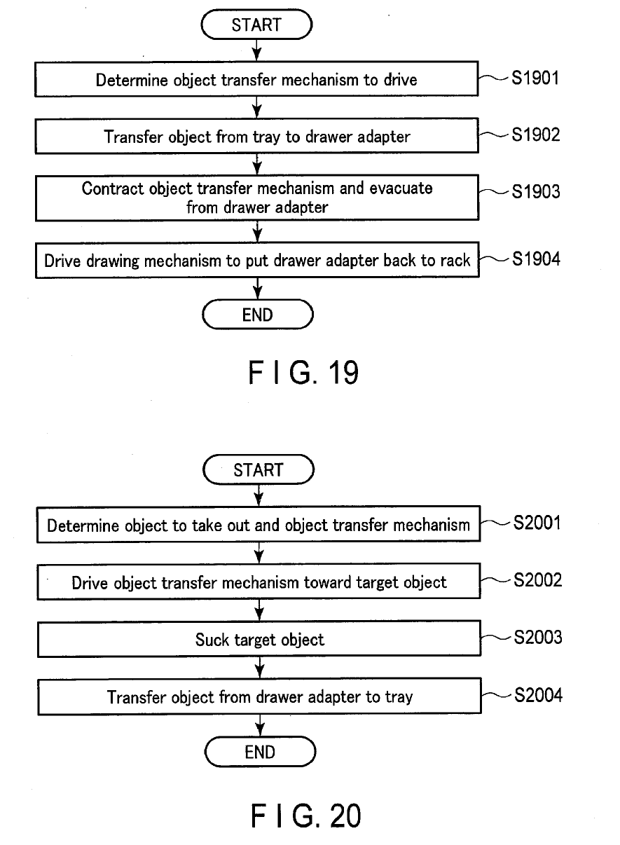

Controlling the placing operation by the object handling apparatus 1300 will now be described with reference to the flowchart in FIG. 19. The descriptions will assume a state in which the object positioning in step S1206 has been complete.

In step S1901, the controller 1103 determines the object transfer mechanism 1302 to drive, in light of the number of objects for transfer to the drawer adapter 200.

In step S1902, the controller 1103 drives the head 1304 of the object transfer mechanism 1302 in accordance with a predetermined drive amount so that the head 1304 pushes the objects from the tray 1351 to the drawer adapter 200.

In step S1903, upon completion of the object transfer, the controller 1103 causes the object transfer mechanism 1302 to contract and evacuate from the area above the drawer adapter 200 and the horizontal member 102.

In step S1904, the controller 1103 drives the drawing mechanism 104 in such a manner as to push the third plate 203 of the drawer adapter 200 so that the drawer adapter 200 will be returned to the rack 601. Specifically, a pressure sensor, etc. may, for example, be adopted to detect a contact between the drawing mechanism 104 and the front face of the third plate 203. Then, the drawing mechanism 104 may be driven until obtaining the pressure value indicative of the second plate 202 having come into contact with the back-end face of the rack. Note that, when putting the drawer adapter 200 back to the rack, it is desirable that the vertical movement mechanism 106 is moved upward so that the drawer adapter 200 is located higher than the level of the shelf in the rack 601.

Controlling the taking-out operation by the object handling apparatus 1300 will be described with reference to the flowchart in FIG. 20.

In step S2001, the controller 1103 determines the taking-out target objects on the drawer adapter 200, as well as the corresponding object transfer mechanisms 1302. The determination of the target objects may be based on, for example, the inspection operation.

In step S2002, the controller 1103 drives the object transfer mechanism 1302 so that the head 1304 can vacuum-suction the target object 301. Specifically, the head 1304 of the object transfer mechanism 1302 is caused to proceed in the x direction by the cylinder 1303, until contacting the object 301.

In step S2003, the controller 1103 controls the object transfer mechanism 1302 to vacuum-suction the object.

In step S2004, the controller 1103 drives the object transfer mechanism 1302 to transfer the object from the drawer adapter 200 to the tray 1351. The processes in steps S1206 and S1904 may be performed thereafter.

Additionally, the target objects to take out from the drawer adapter 200 may be determined by sending the scan information read by the scanner 1001 to a Point-of-Sale (POS) system via a network (not illustrated), and obtaining the feedback including expiration dates, etc. from the POS system.

The second embodiment described above can realize the automation of the placing operation and the taking-out operation for FIFO in a simple and low-cost manner, by providing the object transfer mechanism capable of transferring objects.

### Third Embodiment

In the second embodiment, the object handling apparatus 1300 performs the placing operation using the new objects from the container 1350 on the cart 109. The third embodiment differs from the second embodiment in that the container 1350 itself is conveyed from another cart, a container cart 2101.

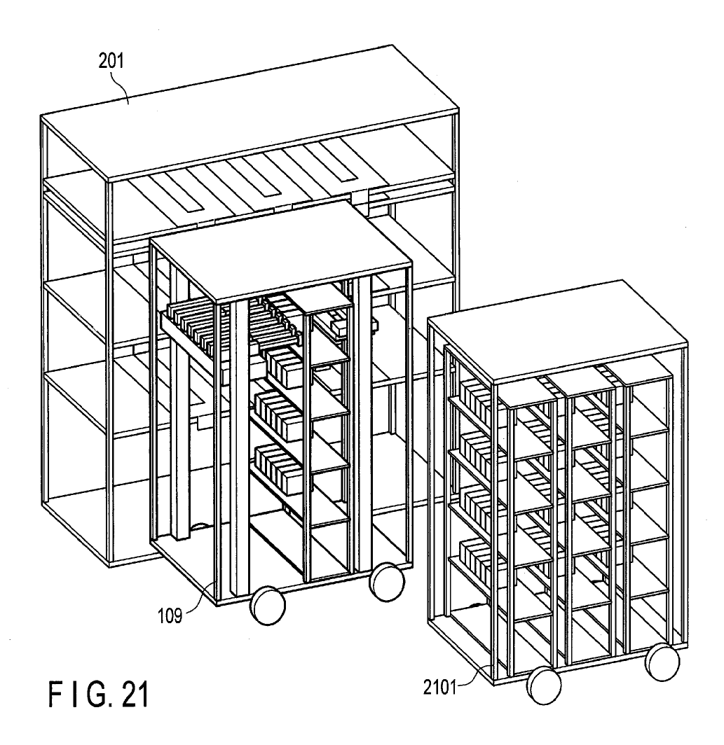

The container transfer process according to the third embodiment will be described with reference to FIG. 21.

FIG. 21 is a conceptual diagram for the process of transferring the container 1350. As shown in FIG. 21, multiple containers 1350 are provided on the container cart 2101. The container cart 2101 is freely movable. By bringing the container cart 2101 into line with the cart 109 on which the object handling apparatus 1300 is mounted, the new containers 1350 can be sequentially transferred onto the cart 109. Accordingly, the placing operation and the taking-out operation can be performed with an enhanced efficiency.

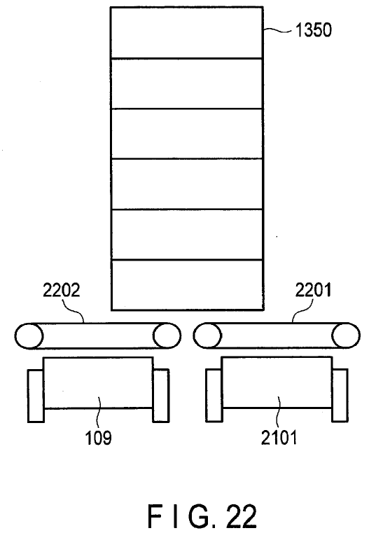

A specific example of the container transfer process will be described with reference to FIG. 22.

FIG. 22 schematically shows the cart 109 and the container cart 2101. The container cart 2101 includes a belt conveyor 2201, and the cart 109 includes a belt conveyor 2202. By synchronizing the movements of the belt conveyor 2201 and the belt conveyor 2202, the new containers 1350 can be transferred from the container cart 2101 to the cart 109. Also, empty containers 1350, for which the operations on the cart 109 have been complete, can be conversely transferred to the container cart 2101 by reversing the rotational direction of the belt conveyor 2201 and the belt conveyor 2202.

The belt conveyor 2201 may be an independent belt conveyor provided on at least the floor portion of the container cart 2101 intended to place the container 1350.

The belt conveyor 2202 may be provided on at least the floor portion of the cart 109 intended to place the container 1350.

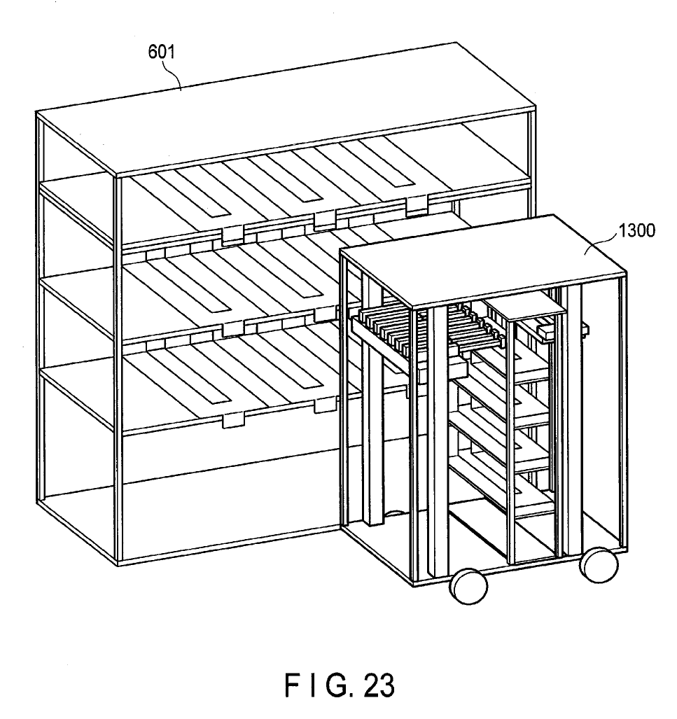

An operation of arranging the drawer adapters 200 will be described with reference to FIG. 23.

When, for example, launching a store or a warehouse, arranging a number of drawer adapters 200 into racks can be a task that requires a great deal of manpower and time. The object handling apparatus according to the embodiments can therefore cover the arrangement task.

Specifically, empty drawer adapters 200 are provided in the container 1350. The object transfer mechanism 1302 pushes the drawer adapter 200 onto the horizontal member 102. The drawer adapter 200 transferred to the horizontal member 102 is then put into the rack 601 by the third plate 203 pushed by the drawing mechanism 104. By repeating this process, the operation of arranging the drawer adapters 200 can be finished.

By use of the container cart, the third embodiment described above can realize the automated loading and unloading of the containers with the object handling apparatus. The third embodiment can therefore achieve enhanced efficiency in the operations.

The above drawer adapters 200, as well as the drawer adapter 400 according to the modification example, have been exemplified with the hole 204. However, the hole 204 need not be formed if the object positioning mechanism 105 is configured to cause, from above, the objects to shift toward the front side.

The configuration of the object positioning mechanism 105 to shift the objects toward the front side by the action from above is, for example, a configuration that adopts an arm capable of gripping objects and also capable of extending and contracting. By gripping or hooking the rearmost object on the drawer adapter, the arm may move the objects toward the front side.

In addition, the drawing mechanism 104 and the object positioning mechanism 105 may be substituted by a single mechanism.

Instructions for the processing sequence in the embodiments may be executed by a software program. The same effects as the mentioned detections may be obtained by storing the program in a general-purpose computer system in advance and reading the program. The instructions in the embodiments may be recorded as a computer-executable program in a magnetic disk (flexible disk, hard disk, etc.), an optical disk (CD-ROM, CD-R, CD-RW, DVD-ROM, DVD±R, DVD±RW, Blu-ray (registered trademark) disc, etc.), a semiconductor memory, or a similar type recoding medium. Any recording format may be employed as long as the format is readable by a computer or an embedded system. The same operations as the detections in the embodiments may be realized when the computer reads the program from the recording medium, and the instructions in the program are executed by the CPU based on the program. As a matter of course, the computer may acquire and read the program through a network. In addition, an OS (operation system) running on the computer, database management, software, and MW (middleware) such as a network may perform some of the processes based on the instructions in the program stored in the computer or the embedded system or read from the recording medium, for realizing the embodiments. Furthermore, the recording medium in the embodiments is not limited to a medium independent from the computer or the embedded system, but may be a recording medium that downloads the program transferred through a LAN or the Internet, and stores or temporarily stores the program. In addition, the number of recording media is not limited to “1”. The case of performing the processes using multiple recording media is also covered by the embodiments, even with any configuration of the medium employed.

The computer or the embedded system in the embodiments may perform the respective processes based on the program stored in the recording medium, and may be configured by any devices such as a personal computer and a microcomputer, and a system comprising multiple devices connected through a network. In addition, the computer in the embodiments is not limited to a personal computer, but may include an arithmetic processing device in an information processing apparatus, and a microcomputer. The computer may collectively refer to apparatuses or devices that can realize the functions in the embodiments using a program.

While certain embodiments have been described, they are presented by way of example only, and are not intended to limit the scope of the invention. Indeed, the novel embodiments described herein may be embodied in a variety of other forms. Various omissions, substitutions, and changes in the form of the embodiments may be tolerated without departing from the spirit of the invention. The accompanying claims and their equivalents are intended to cover such forms or modifications as would fall within the scope and spirit of the inventions.

What is claimed is:

1. An object handling apparatus comprising:
a first mechanism which draws an adapter arranged in a rack, one or more objects being placed on the adapter; and
a second mechanism which moves the one or more objects toward a side where the one or more objects are taken out from the adapter.

2. The apparatus according to claim 1, wherein
the adapter comprises:
a first plate which contacts with the rack, the one or more objects are placed on a surface of the first plate;
a second plate which is arranged at a first edge of the first plate and extends in a direction perpendicular to the surface of the first plate; and
a third plate which is arranged at a second edge opposite the first edge and extends in a direction perpendicular to the surface of the first plate, and
the first mechanism draws the adapter using the third plate.

3. The apparatus according to claim 2, wherein
a continuous hole is formed in the first plate and the second plate, and
the second mechanism enters the continuous hole and moves the one or more objects from a rear side to a foreside in an arrangement direction of the one or more objects.

4. The apparatus according to claim 1, further comprising a scanner which scans the one or more objects from at least one direction.

5. The apparatus according to claim 1, further comprising a third mechanism which inserts a new object into a space between the one or more objects and the adapter when the one or more objects have been moved toward a foreside in an arrangement direction of the one or more objects.

6. The apparatus according to claim 5, wherein the third mechanism takes out at least one of the one or more objects on the adapter.

7. The apparatus according to claim 5, wherein the third mechanism comprises a suction member which suctions the one or more objects.

8. The apparatus according to claim 5, further comprising a cart on which the first mechanism, the second mechanism, and the third mechanism are mounted.

9. The apparatus according to claim 8, further comprising a container which contains objects to be transferred to the adapter and is placed on the cart.

10. The apparatus according to claim 9, further comprising a fourth mechanism to transfer the container to another location.
